(19) United States
(12) Patent Application Publication
(10) Pub. No.: US 2013/0022377 A1
(43) Pub. Date: Jan. 24, 2013

(54) IMAGE FORMING APPARATUS THAT CARRIES OUT COLOR REGISTRATION ADJUSTMENT, CONTROL METHOD THEREFOR, AND STORAGE MEDIUM

(71) Applicants: Mitsuhiro SUGETA, Abiko-shi (JP); Hirokazu KODAMA, Ryugasaki-shi (JP)

(72) Inventors: Mitsuhiro SUGETA, Abiko-shi (JP); Hirokazu KODAMA, Ryugasaki-shi (JP)

(73) Assignee: CANON KABUSHIKI KAISHA, Tokyo (JP)

(21) Appl. No.: 13/551,886

(22) Filed: Jul. 18, 2012

(30) Foreign Application Priority Data
Jul. 22, 2011 (JP) 2011-161078

(51) Int. Cl. G03G 15/01

(52) U.S. Cl. 399/301

(57) ABSTRACT

An image forming apparatus which is capable of improving the accuracy of detecting the amount of misregistration. A control unit controls a plurality of image forming units so as to form a color registration pattern on a image bearing member. A detection unit detects diffusely reflected light reflected on the image bearing member and the color registration pattern. The control unit compares a first output value output by the detection unit detecting the surface of the image bearing member with a second output value output by the detection unit detecting a low-reflectivity toner pattern formed on the image bearing member, and determines a density of the color registration pattern corresponding to the low-reflectivity toner pattern based on a result of the comparison.

### BACKGROUND OF THE INVENTION

1. Field of the Invention

The present invention relates to an image forming apparatus, a control method therefor, and a storage medium, in which a color registration pattern is formed on an intermediate transfer member and the pattern is detected using a detecting unit.

2. Description of the Related Art

In a tandem-type color image forming apparatus, the amount of misregistration is calculated based on a detection result of a color registration patterns formed on an intermediate transfer member by a plurality of image forming units, and color misregistration is corrected for. A method that detects a color registration pattern using an optical sensor or the like disposed in the vicinity of the intermediate transfer member is known as a method for detecting a color registration pattern formed on the intermediate transfer member. Specifically, a light emitting device radiates light onto the intermediate transfer member, and a light receiving device such as a photo-sensor detects a difference in the amount of reflected light between a surface of the intermediate transfer member and a color registration pattern formed on the intermediate transfer member.

Methods that detect reflected light using an optical sensor include a regularly reflected light detection method and a diffusely reflected light detection method. The regularly reflected light detection method detects regularly reflected light of light radiated onto the intermediate transfer member. On the other hand, the diffusely reflected light detection method detects diffusely reflected light of light radiated onto a color registration pattern.

Both a surface of the intermediate transfer member and a black (K) toner pattern formed on the intermediate transfer member have low reflectivity. For this reason, in a case where a surface of the intermediate transfer member and a black (K) toner pattern formed on the intermediate transfer member are detected using the diffusely reflected light detection method, it is difficult to detect the black (K) toner pattern because an amount of diffusely reflected light from the intermediate transfer member and an amount of diffusely reflected light from the black (K) toner pattern are substantially the same.

Accordingly, there has been proposed a method that forms a toner pattern of a high-reflectivity color as a base, and forms a K toner pattern on the formed base (see Japanese Laid-Open Patent Publication (Kokai) No. 2007-156159).

FIG. 13 is a schematic diagram showing waveforms of sensor output signals obtained when M (magenta) toner patterns 905 and 901, a K toner pattern 906, and a Y toner pattern 902 are detected using an optical sensor. In the example shown in the figure, the K toner pattern 906 is formed on the Y toner pattern 915 with high reflectivity formed as a base.

In the example shown in FIG. 13, waveforms of the respective toner patterns are distorted due to optical distortion of the optical sensor. A sensor output signal obtained when diffusely reflected light from the Y toner pattern 902 is detected using the optical sensor and a sensor output signal obtained when diffusely reflected light from the M toner pattern 901 using the optical sensor are equal in output level (density).

The sensor output signal of the Y toner pattern 902 and the sensor output signal of the M toner pattern 901 are each compared with a threshold voltage Vth 921, and based on the comparison results, a barycenter of the Y toner pattern 902 and a barycenter of the M toner pattern 901 are calculated. Even when the optical sensor has optical distortion, ΔM2 and ΔY2, each of which is a difference between the barycentric position of each toner pattern and an ideal position of the toner pattern, are equal. In the diffusely reflected light detection method, even when the optical sensor has optical distortion, the amount of relative color misregistration between high-reflectivity toner patterns can be detected with high accuracy by making the densities of respective toner patterns equal.

A waveform of a sensor output signal of the low-reflectivity K toner pattern 906 and a waveform of a sensor output signal of the M toner pattern 905 are upside down as shown in the figure. Thus, the position of the threshold voltage Vth 921 relative to the waveform of the K toner pattern and the position of the threshold voltage Vth 921 relative to the waveform of the M toner pattern are different. As a result, ΔM1≠ΔK1, and hence the amount of relative color misregistration between a high-reflectivity toner pattern and a low-reflectivity toner pattern cannot be accurately detected.

### SUMMARY OF THE INVENTION

The present invention provides an image forming apparatus and a control method therefor which are capable of improving the accuracy of detecting the amount of misregistration, as well as a computer-readable storage medium storing a program for implementing the method.

Accordingly, a first aspect of the present invention provides an image forming apparatus comprising an image bearing member, a plurality of image forming units, a control unit configured to control the plurality of image forming units so as to form a color registration pattern on the image bearing member, and a detection unit configured to detect diffusely reflected light reflected on the image bearing member and the color registration pattern, wherein the control unit compares a first output value output by the detection unit detecting the surface of the image bearing member with a second output value output by the detection unit detecting a low-reflectivity toner pattern formed on the image bearing member, and determines a density of the color registration pattern corresponding to the low-reflectivity toner pattern based on a result of the comparison.

Accordingly, a second aspect of the present invention provides a control method for an image forming apparatus which has an image bearing member, a plurality of image forming units, a control unit that controls the plurality of image forming units so as to form a color registration pattern on the image bearing member, and a detection unit that detects diffusely reflected light reflected on the image bearing member and the color registration pattern, comprising a control step of the control unit comparing a first output value output by the detection unit detecting the surface of the image bearing member with a second output value output by the detection unit detecting a low-reflectivity toner pattern formed on the image bearing member, and determining a density of the color registration pattern corresponding to the low-reflectivity toner pattern based on a result of the comparison.

Accordingly, a third aspect of the present invention provides a non-transitory computer-readable storage medium storing a program for causing an image forming apparatus to implement a control method as described above.

According to the present invention, the accuracy of detecting the amount of misregistration can be improved.

Further features of the present invention will become apparent from the following description of exemplary embodiments (with reference to the attached drawings).

### BRIEF DESCRIPTION OF THE DRAWINGS

FIG. 1 is a diagram schematically showing an arrangement of image forming units of an image forming apparatus according to the present embodiment.

FIG. 2 is a view showing exemplary color registration patterns formed on an intermediate transfer belt.

FIG. 3 shows an M toner pattern and K toner pattern, in which the M toner pattern and the K toner pattern in the color registration patterns are enlarged in (a), and cross-sections of the M toner pattern and the K toner pattern at a detecting position are shown in (b).

FIG. 4 is a diagram schematically showing an arrangement of a pattern sensor.

FIG. 5 is a block diagram schematically showing an arrangement of a color registration adjustment control unit in the image forming apparatus shown in FIG. 1.

FIG. 6 is a diagram showing the relationship between the color registration patterns and waveforms of output signals (an analog signal and a digital signal) from the pattern sensor.

FIG. 7 is a flowchart showing the flow of a normal printing operation in the image forming apparatus 1 shown in FIG. 1.

FIGS. 8A and 8B are flowcharts showing the details of a pattern density adjusting process in step S506 in FIG. 7.

FIG. 9 is a diagram showing exemplary toner patterns used in the pattern density adjusting process.

FIG. 10 is a diagram useful in explaining a process to determine the densities of YMC toner patterns

FIG. 11 is a flowchart showing the details of an automatic registration correction process in step S507 in FIG. 7.

FIGS. 12A and 12B are diagrams showing waveforms of a sensor output before and after the densities of pattern images for automatic registration correction are adjusted, in which FIG. 12A shows waveforms before density adjustment and FIG. 12B shows waveforms after density adjustment.

FIG. 13 is a schematic diagram showing waveforms of sensor output signals obtained when M toner patterns, a K toner pattern, and a Y toner pattern are detected using an optical sensor.

### DESCRIPTION OF THE EMBODIMENTS

The present invention will now be described in detail with reference to the drawings showing embodiments thereof.

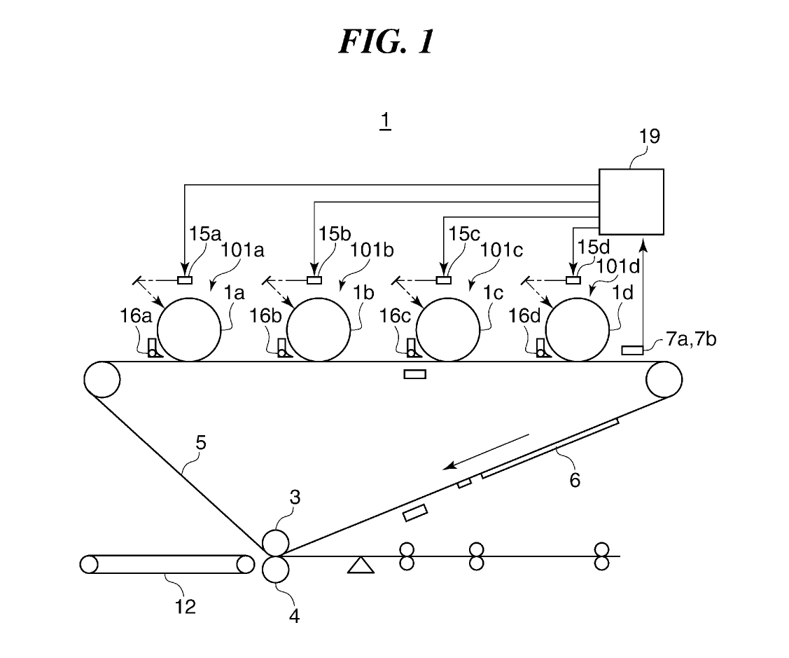

FIG. 1 is a diagram schematically showing an arrangement of image forming units of an image forming apparatus according to the present embodiment.

The image forming apparatus 1 is a so-called tandem-type color image forming apparatus having a plurality of image forming units 101a, 101b, 101c, and 101d for yellow (Y), magenta (M), cyan (C), and black (K) colors, respectively. The image forming units 101a, 101b, 101c, and 101d have laser scanner units 15a, 15b, 15c, and 15d, photosensitive drums 1a, 1b, 1c, and 1d, which are image carriers, and developing devices 16a, 16b, 16c, and 16d.

Latent images formed on the photosensitive drums 1a, 1b, 1c, and 1d, by the laser scanner units 15a, 15b, 15c, and 15d are developed by the developing devices 16a, 16b, 16c, and 16d. Toner images formed on the photosensitive drums 1a, 1b, 1c, and 1d, are successively transferred onto an endless intermediate transfer belt (intermediate transfer member) 5 in a manner being superposed on top of one another, and as a result, a color toner image 6 is formed. The color toner image 6 is transferred onto a sheet at a junction between a belt supporting roller 3 and a transfer roller 4 (transfer position), and the sheet is sent to a fixing unit, not shown, by a conveying belt 12. The toner image is then fixed on the sheet, which in turn is discharged from the apparatus.

Pattern sensors 7a and 7b are reflective optical sensors for detecting color registration patterns formed on the intermediate transfer belt 5, and is disposed in the vicinity of the intermediate transfer belt 5. In the present embodiment, the two pattern sensors 7a and 7b are used to detect color registration patterns formed in two places on the intermediate transfer belt 5.

A control unit 19 controls the image forming units 101a, 101b, 101c, and 101d to form images on the intermediate transfer belt 5. Also, the control unit 19 calculates the amount of misregistration from output signals from the respective pattern sensors 7a and 7b, and based on the amount of misregistration, controls the image forming units 101a, 101b, 101c, and 101d.

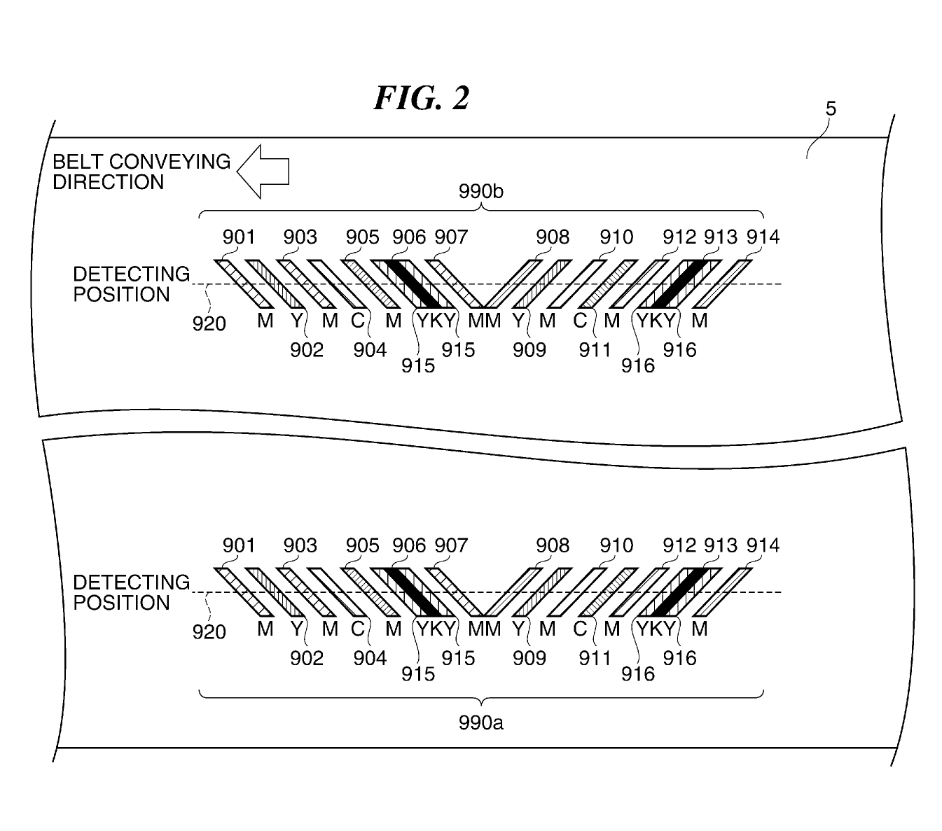

In a tandem-type image forming apparatus in which four image forming units are arranged as shown in the figure, color misregistration occurs due to displacement of the positions of the formed images, deformation of the formed images and the like caused by an installation error of four photosensitive drums and laser scanner units or a temperature fluctuation of an optical mirror or the like. For this reason, a color registration adjustment is carried out during standby or during an interval between image forming processes. In the color registration adjustment, the control unit 19 controls the image forming units 101a, 101b, 101c, and 101d to form color registration patterns 990a and 990b as shown in FIG. 2 in a conveying direction in which the intermediate transfer belt 5 is conveyed, on the intermediate transfer belt 5 and at two different positions in a direction perpendicular to the conveying direction. On the intermediate transfer belt 5, the direction perpendicular to the conveying direction corresponds to a main scanning direction of light radiated from the laser scanner units 15a, 15b, 15c, and 15d.

Referring to FIG. 2, in the color registration patterns 990a and 990b, toner patterns of the respective yellow (Y), cyan (C), and black (K) colors are placed between tonner patterns of the magenta (M) color which is a reference color. The color registration pattern 990a and 990b are each comprised of two patterns consisting of a first pattern and a second pattern which are inclined at about 45 degrees in different directions with respect to the conveying direction. The first pattern is comprised of M toner patterns 901, 903, 905, and 907, Y toner patterns 902 and 915 (base), C toner pattern 904, and K toner pattern 906. The second pattern is comprised of M toner patterns 908, 910, 912, and 914, Y toner patterns 909 and 916 (base), C toner pattern 911, and K toner pattern 913. Detecting positions 920 are detecting positions detected by the pattern sensors 7a and 7b when they detect the color registration patterns 990a and 990b.

Based on positions of the respective toner patterns of the color registration patterns 990a and 990b detected by the pattern sensors 7a and 7b, the control unit 19 calculates the amounts of misregistration of Y, C, and K with reference to M in the main scanning direction and a sub scanning direction. The main scanning direction corresponds to the direction perpendicular to the conveying direction in which intermediate transfer belt 5 is conveyed, and the sub scanning direction corresponds to the conveying direction. A description will be given later of how to calculate the amounts of misregistration in the main scanning direction and the sub scanning direction.

The pattern sensors 7a and 7b output, to the control unit 19, detection signals indicative of the detecting positions 920 on the intermediate transfer belt 5.

The control unit 19 calculates the amounts of misregistration based on the detection signals input from the pattern sensors 7a and 7b, and controls the image forming units 101a to 101d based on the amounts of misregistration. Specifically, in a case where color misregistration in the main scanning direction is corrected for, the control unit 19 controls the laser scanner units 15a to 15d to adjust image formation timing from an image formation reference position (BD signal) in the main scanning direction on a per-sub-pixel basis based on the amount of color misregistration in the main scanning direction. On the other hand, in a case where color misregistration in the sub scanning direction is corrected for, the control unit 19 controls phases in which polygon mirrors in the laser scanner units 15a, 15b, 15c, and 15d are operated, and adjusts image formation timing from an image formation reference position (image TOP signal) in the sub scanning direction on a per-sub-pixel basis in response to the amount of color misregistration in the sub scanning direction.

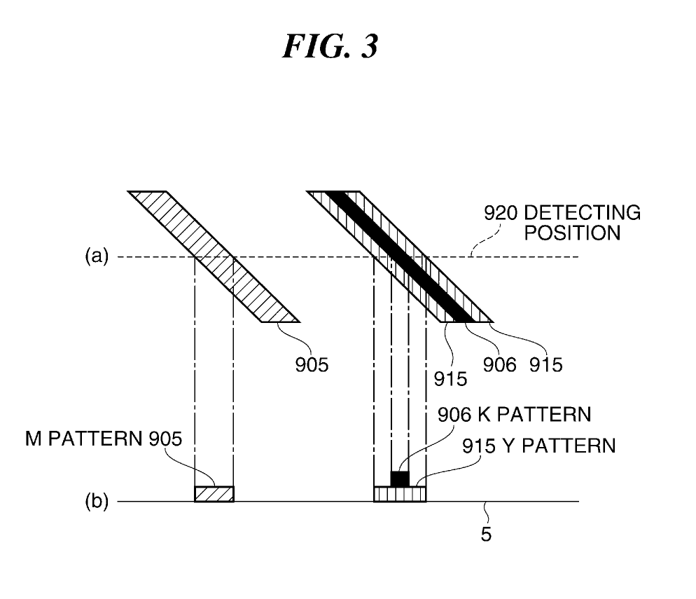

In FIG. 3, the M toner pattern 905 and the K toner pattern 906 in the color registration patterns 990a and 990b are enlarged in (a), and cross-sections of the M toner pattern 905 and the K toner pattern 906 at the detecting position 920 are shown in (b).

The M toner pattern 905 formed on the intermediate transfer belt 5 is formed of one-colored toner. On the other hand, the Y toner pattern 915 is formed as a base, and the K toner pattern 906 is formed on the Y toner pattern 915 as a base.

The pattern sensors 7a and 7b are optical sensors that receive diffusely reflected light. Both the surface of an intermediate transfer member and a black (K) toner pattern formed on the intermediate transfer member have low reflectivity. For this reason, the detection result of a diffusely reflected light from the black (K) toner pattern and the detection result of a diffusely reflected light from the intermediate transfer member are substantially the same. Therefore, it is difficult to detect the black (K) toner pattern based on the detection results. Accordingly, a toner pattern of a high-reflectivity color is formed as a base, and a K toner pattern is formed on the formed base. It should be noted that similarly, the Y toner pattern 916 is formed as a base under the K toner pattern 913 in the color registration patterns 990a and 990b as well.

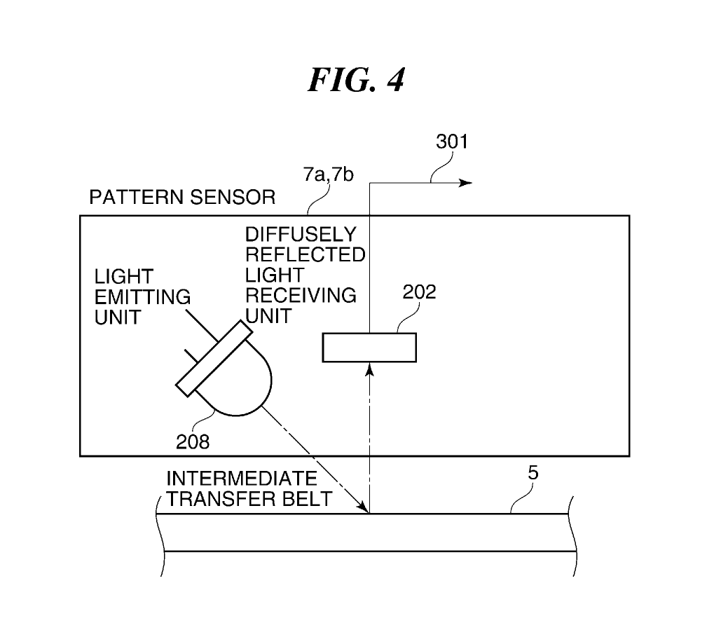

FIG. 4 is a diagram schematically showing an arrangement of the pattern sensors 7a and 7b.

The pattern sensors 7a and 7b each have a light emitting unit (light emitting device) 208, which is an illuminating unit, and a diffusely reflected light receiving unit (light receiving device) 202, which is a light receiving unit. The light emitting unit 208 and the diffusely reflected light receiving unit 202 are disposed so that diffusely reflected light of light radiated from the light emitting unit 208 onto the intermediate transfer belt 5 or a color registration pattern formed on the intermediate transfer belt 5 can fall on the diffusely reflected light receiving unit 202. The diffusely reflected light receiving unit 202 generates a photoelectric current according to the amount of received light, converts the current into a voltage, and outputs analog signals 301a and 301b.

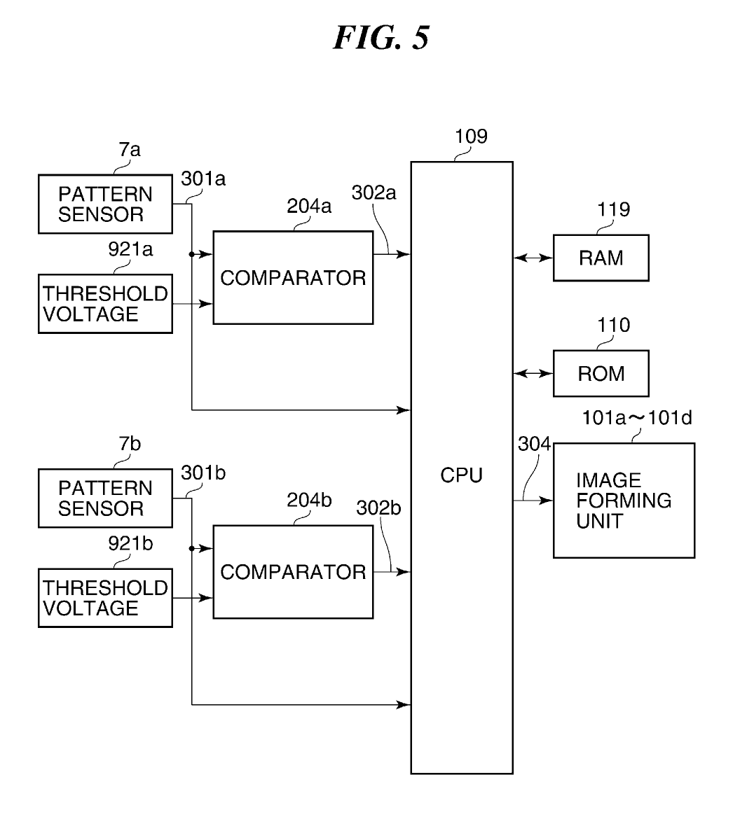

FIG. 5 is a block diagram schematically showing an arrangement of a color registration adjustment control unit in the image forming apparatus 1 shown in FIG. 1.

A CPU 109 controls parts in the image forming apparatus 1 by reading and executing program data stored in a ROM 110. A RAM 119 holds backup data for use in control and acts as a work RAM to temporarily hold data for use in control.

The CPU 109 outputs a control signal 304 to the image forming units 101a to 101d. Based on the input control signal, the image forming units 101a to 101d form a normal print image. On the occasion of color registration adjustment, the image forming units 101a to 101d form the color registration patterns 990a and 990b shown in FIG. 2 on the intermediate transfer belt 5.

The pattern sensor 7a receives diffusely reflected light from the surface of the intermediate transfer belt 5 or the color registration pattern 990a, carries out photoelectric conversion, and outputs the analog signal 301a to a comparator 204a and the CPU 109. The comparator 204a receives a threshold voltage Vth 921a and the analog signal 301a, compares a voltage of the analog signal 301a with the threshold voltage Vth 921a, and outputs a binarized digital signal 302a to the CPU 109.

The pattern sensor 7b receives diffusely reflected light from the surface of the intermediate transfer belt 5 or the color registration pattern 990b, carries out photoelectric conversion, and output the analog signal 301b to a comparator 204b and the CPU 109. The comparator 204b receives a threshold voltage Vth 921b and the analog signal 301b, compares a voltage of the analog signal 301b with the threshold voltage Vth 921b, and outputs a binarized digital signal 302b to the CPU 109.

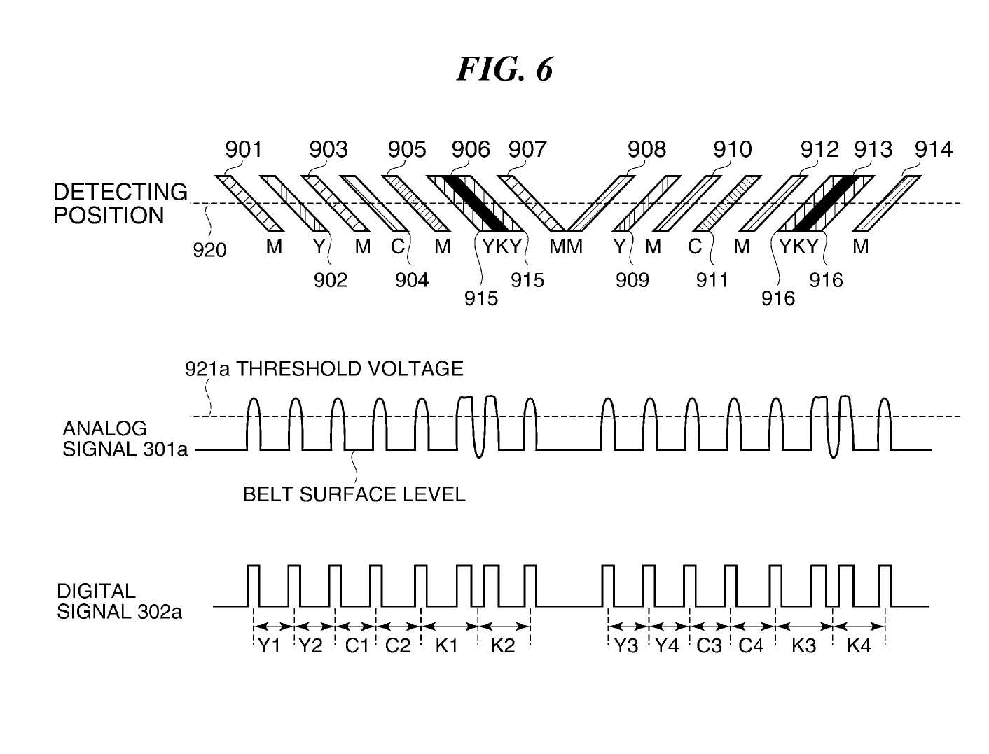

FIG. 6 is a diagram showing the relationship between the color registration pattern 990a and waveforms of output signals (the analog signal 301a and the digital signal 302a) from the pattern sensor 7a.

In the analog signal 301a, the voltage levels in the surface of the intermediate transfer belt 5 and the K toner patterns are low, and the voltage levels in the YMC toner patterns are high.

The digital signal 302a is a signal obtained by the comparator 204a carrying out analog-to-digital conversion of the analog signal 301a using the threshold voltage Vth 921a. By detecting time intervals Y1, Y2, C1, C2, K1, K2, Y3, Y4, . . . between adjacent rectangular waveforms from the digital signal 302a, the amounts of misregistration of the respective colors with reference to magenta (the amounts of relative displacement of the respective color patterns) can be calculated. Specifically, first, a barycentric position of a region regarded as a toner pattern region based on the digital signal 302a is calculated as a position of a toner pattern. Then, the amount of misregistration is calculated based on the position of the toner pattern.

Based on the digital signal 302a, the CPU 109 calculates the time intervals Y1, Y2, C1, C2, K1, K2, Y3, Y4, . . . , and successively stores them in the RAM 119. Based on data on the time intervals stored in the RAM 119, the CPU 109 calculates the amounts of misregistration of the respective colors with reference to the M toner patterns. For example, the amount of misregistration of a Y toner pattern in the main scanning direction and the sub scanning direction with reference to a M toner pattern is calculated according to the following expressions (1) and (2):

The amount of misregistration ΔHy in the main scanning direction={(Y4−Y3)/2−(Y2−Y1)/2}/2 (1)

The amount of misregistration ΔVy in the sub scanning direction={(Y4−Y3)/2+(Y2−Y1)/2}/2 (2)

Based on the calculated values ΔHy and ΔVy, the CPU 109 controls the timing with which a Y toner image is written, thus correcting for color misregistration.

Also, the CPU 109 converts the analog signals 301a and 301b input from the pattern sensors 7a and 7b into multi-valued digital signals, and detect the surface state (gloss) of the intermediate transfer belt 5, which will be described later. The pattern sensors 7a and 7b are diffusely reflective optical sensors, and hence when the gloss of the intermediate transfer belt 5 is high, the amount of diffusely reflected light from the surface of the intermediate transfer belt 5 is small, and the output levels of the signals are low. On the other hand, when the gloss of the intermediate transfer belt 5 is low, the amount of diffusely reflected light from the surface of the intermediate transfer belt 5 is large, and the output levels of the signals are high.

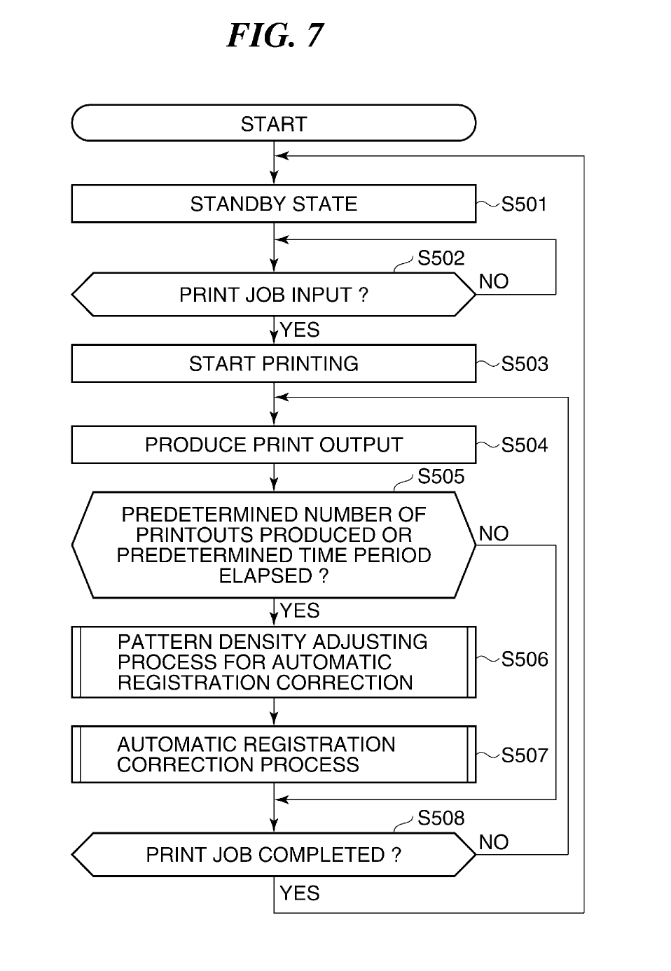

FIG. 7 is a flowchart showing the flow of a normal printing operation in the image forming apparatus 1 shown in FIG. 1.

When a print job is input to the image forming apparatus 1 being in a standby state (step S501) (YES in step S502), the image forming apparatus 1 receives the print job (step S503). The image forming apparatus 1 produces printouts while correcting write timing based on write timing correction values held in the RAM 119 (step S504).

When the number of printouts has become equal to or greater than a predetermined value or a predetermined time period has elapsed (YES in step S505), the image forming apparatus 1 carries out a pattern density adjusting process for determining the densities of pattern images for image writing position adjustment (hereafter referred to as “automatic registration correction”) (step S506). A detailed description will be given later of this pattern density adjusting process.

When the densities of pattern images for automatic registration correction have been determined, the image forming apparatus 1 carries out an automatic registration correction process (step S507). The automatic registration correction process corrects the timing with which images are written on the intermediate transfer belt 5 from the image forming units 101a to 101d. A detailed description will be given later of this automatic registration correction process.

When the whole print job has not yet been completed after the automatic registration correction process was completed (NO in step S508), the process returns to the step S504. Namely, the image forming apparatus 1 produces printouts while correcting write timing based on write timing correction values held in the RAM 119. The image forming apparatus 1 adjusts the densities of pattern images for automatic registration correction and carries out the automatic registration correction process whenever the number of printouts has reached a predetermined number or a predetermined time period has elapsed. When the whole print job has been completed (YES in the step S508), the image forming apparatus 1 is brought into the standby state (step S501).

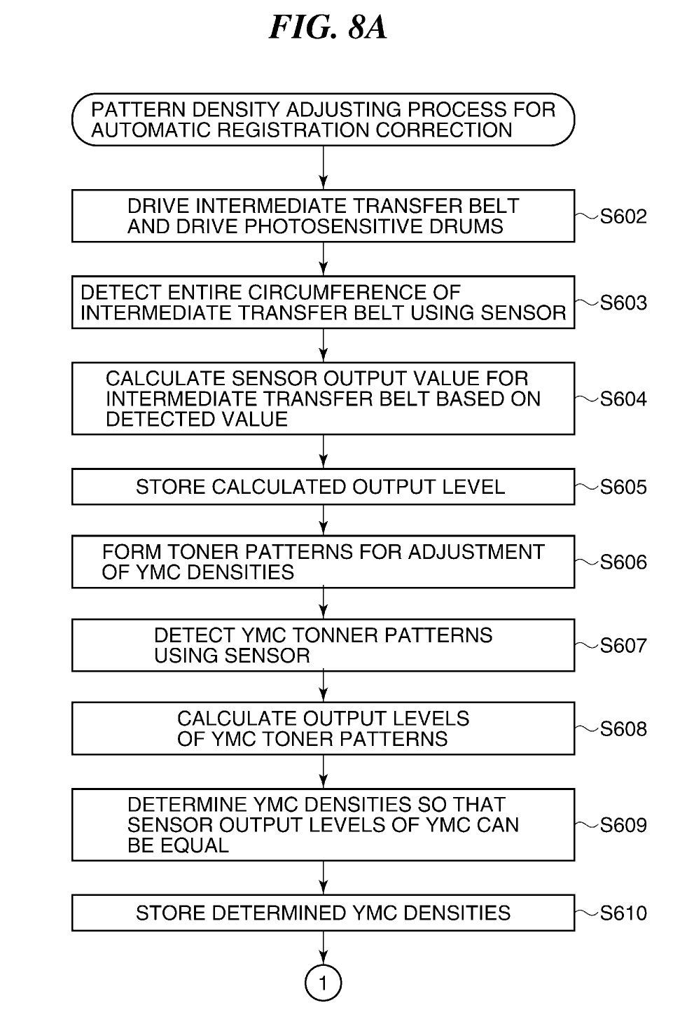

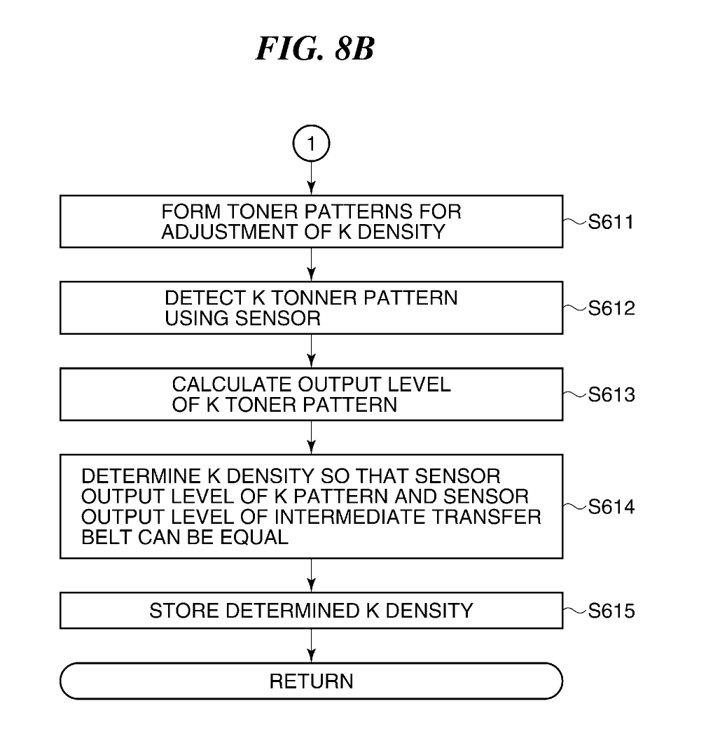

FIGS. 8A and 8B are flowcharts showing the details of the pattern density adjusting process in the step S506 in FIG. 7. This process is carried out by the CPU 109.

The CPU 109 drives the intermediate transfer belt 5 and the photosensitive drums 1a to 1d, (step S602). The pattern sensors 7a and 7b detect the entire circumference of the intermediate transfer belt 5 at predetermined intervals (about 16 ms) (step S603).

The CPU 109 calculates average values from a plurality of detected sensor output values as sensor output levels (first output values) at the time when the pattern sensors 7a and 7b detect the surface of the intermediate transfer belt 5 (step S604) and stores the average values in the RAM 119 (step S605).

The process then proceeds to a sequence for determining the densities of YMC patterns.

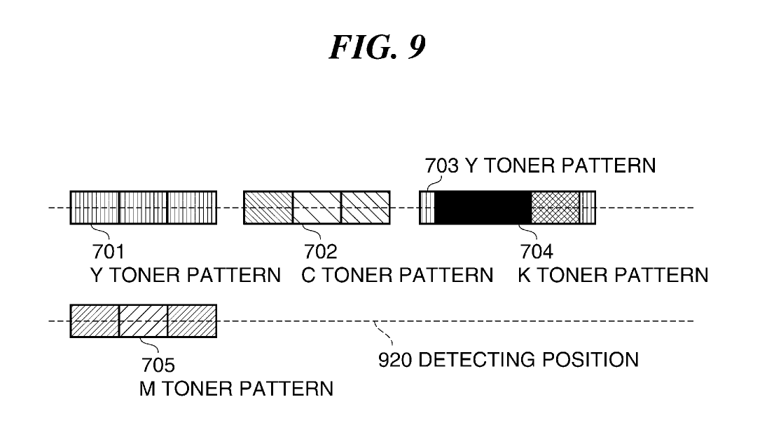

The CPU 109 controls the image forming units 101a to 101d to form density adjustment patterns of high-reflectivity colors on the intermediate transfer belt 5 (step S606). In the present embodiment, a Y toner pattern 701, an M toner pattern 705, and a C toner pattern 702 as shown in FIG. 9 are formed as toner patterns of high-reflectivity colors.

Then, based on output signals from the pattern sensors 7a and 7b, the CPU 109 detects the Y toner pattern 701, the M toner pattern 705, and the C toner pattern 702 (step S607).

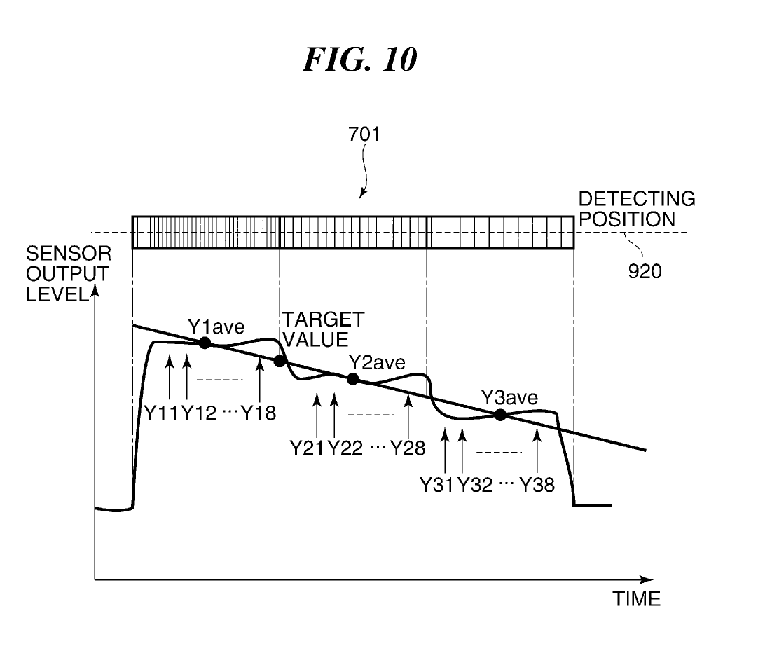

Referring now to FIG. 10, a description will now be given of a process to determine YMC pattern densities.

The Y toner pattern 701 formed on the intermediate transfer belt 5 in the step S606 is comprised of three types of toner patterns of the same color and having different densities. The CPU 109 obtains output signals of eight points (Y11 to Y18, Y21 to Y 28, and Y31 to Y38) from each toner pattern. Then, based on eight sensor output signals obtained from the each toner patterns, the CPU 109 calculates three average values (Y1ave, Y2ave, and Y3ave) (third output values) for the each toner patterns (step S608). The CPU 109 similarly calculates three average values for the M toner pattern 702 and C toner pattern 705, respectively.

Then, based on the calculated average values, the CPU 109 determines the densities of the respective YMC toner patterns so that sensor output levels of the pattern sensors 7a and 7b can be equal to a target value (step S609).

Here, when the one of the three average values is equal to the target value, the density of this toner pattern corresponding to the one average value is determined as a toner pattern density. When none of the three average values of the sensor output levels is equal to the target value, a toner pattern density is estimated using linear interpolation or the like so that sensor output levels of the pattern sensors 7a and 7b can be equal to the target value. In this way, YMC pattern densities are determined so that sensor output levels obtained from the YMC toner patterns can be equal. The CPU 109 then stores the determined YMC pattern densities in the RAM 119 (step S610).

A description will now be given of a process to determine the density of K patterns.

The CPU 109 controls the image forming units 101a to 101d to form three types of K toner patterns 704 having different densities on the Y toner pattern 703 shown in FIG. 9 (step S611). Here, the Y toner pattern 703 is formed with the pattern density determined in the step S609 described above.

The CPU 109 obtains sensor output levels of eight points from each of the three types of K toner patterns 704 having different densities (step S612) using the pattern sensors 7a and 7b. Then, based on the sensor output levels, the CPU 109 calculates three average values (second output values) for the K toner patterns 704 (step S613).

Based on the obtained three average values, the CPU 109 determines the density of K toner patterns so that the sensor output levels of K toner pattern can be equal to the average value of the intermediate transfer belt 5 stored in the step S605 (step S614). It should be noted that in the step S614, when one of the three average values of the K toner patterns 704 is equal to the average value of the intermediate transfer belt 5, the corresponding density is determined as a K toner pattern density.

When none of the three average values of K toner patterns is equal to the average value of the intermediate transfer belt 5, a K toner pattern density is estimated using linear interpolation or the like so that sensor output levels of a K toner pattern can be equal to the average value of the intermediate transfer belt 5.

The CPU 109 then stores the determined K tonner pattern density in the RAM 119 (step S615).

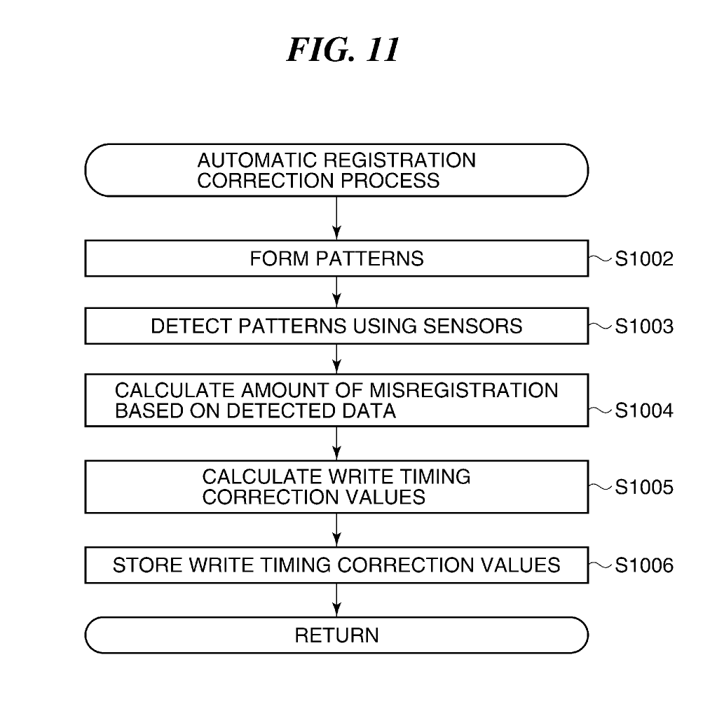

FIG. 11 is a flowchart showing the details of the automatic registration correction process (color registration adjustment) in the step S507 in FIG. 7. This process is carried out by the CPU 109.

The CPU 109 controls the image forming units 101a to 101d to form the color registration patterns 909a and 909b shown in FIG. 2 on the intermediate transfer belt 5 (step S1002), and causes the pattern sensors 7a and 7b to detect them (step S1003).

Then, based on sensor outputs from the pattern sensors 7a and 7b, the CPU 109 calculates the amounts of misregistration of Y, C, and K relative to M which is a reference color (step S1004). In accordance with the calculated amounts of misregistration, the CPU 109 then calculates write timing correction values for the respective colors (step S1005), and stores the calculated write timing correction values in the RAM 119 (step S1006). Color misregistration can be corrected for by correcting write timing based on the write timing correction values stored in the RAM 119 and producing printouts.

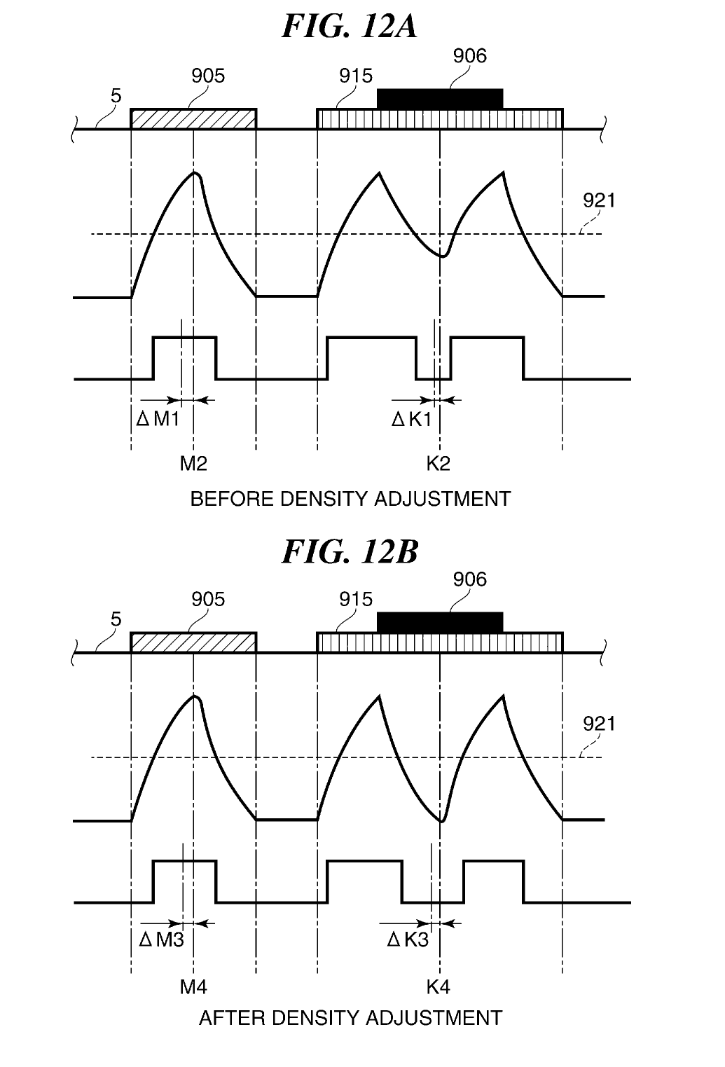

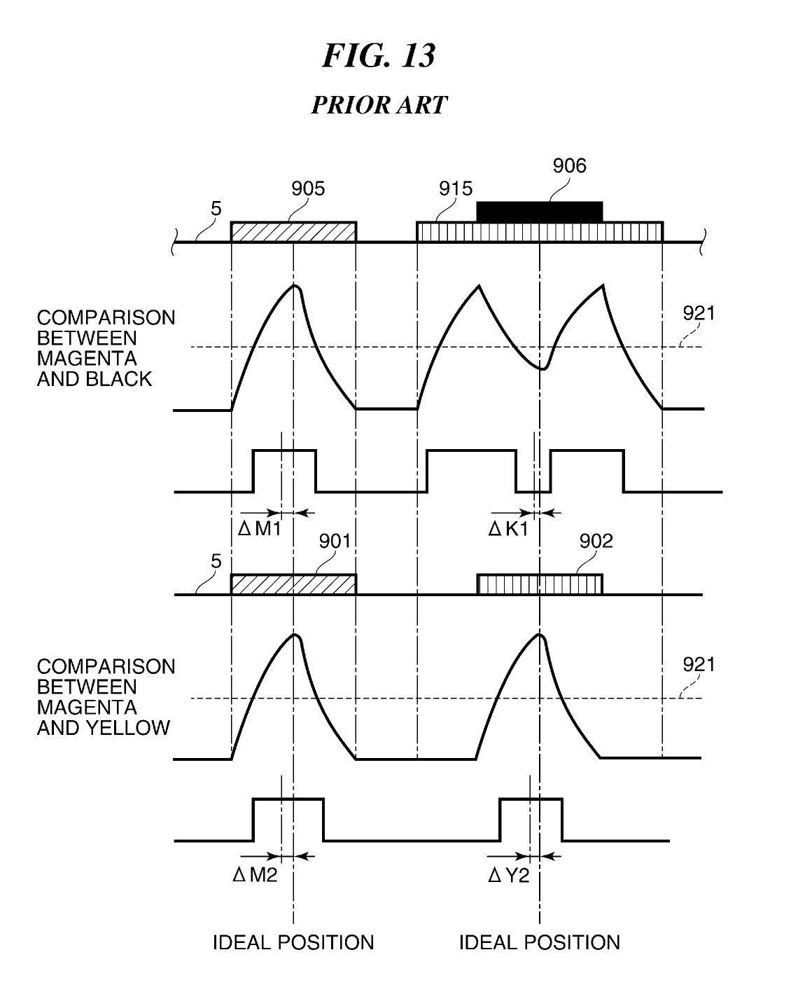

FIGS. 12A and 12B are diagrams showing waveforms of a sensor output before and after the densities of pattern images for automatic registration correction are adjusted.

When the pattern sensors 7a and 7b have optical distortion, ΔM1≠ΔK1 due to waveform distortion as shown in FIG. 12A if the density of the K toner pattern 906 has not been adjusted. Thus, the amount of relative misregistration cannot be accurately detected.

It should be noted that in the example shown in FIGS. 12A and 12b, the output level of the M toner pattern 905 and the output level of the Y toner pattern 915 are the same. However, if the density adjustment of YMC toner levels in the steps S606 to S610 in FIGS. 8A and 8B has not been carried out, the output level of the M toner pattern 905 and the output level of the Y toner pattern 915 may not be the same. If the output level of the M toner pattern 905 and the output level of the Y toner pattern 915 are different, the accuracies of ΔM1 and ΔK1 will further decrease.

After the densities of pattern images for automatic registration adjustment are adjusted, the output level of the M toner pattern 905 and the output level of the Y toner pattern 915 are the same, and also the output level of the K toner pattern 906 and the output level of the intermediate transfer belt 5 are the same as shown in FIG. 12B. As a result, ΔM3=ΔK3, and hence even when the pattern sensors 7a and 7b have optical distortion, the amount of relative misregistration can be detected with high accuracy.

Automatic registration adjustment (color registration adjustment) is registration using the amount of relative misregistration based on the reference color. Therefore, even when detected positions of patches of the respective colors deviate from ideal positions, the amounts of relative misregistration can be detected with high accuracy as long as the amounts of misregistration of the respective colors are equal.

It should be noted that although in the present embodiment described above, the method that carries out automatic registration adjustment by forming pattern images on the intermediate transfer belt 5 is used, a method that forms patterns on a continuous sheet or a method that forms patterns on a sheet conveyed by a sheet conveying belt may be used.

Moreover, although in the present embodiment described above, the image forming apparatus that performs printing using the electrophotographic process is taken as an example, this is not limitative, but the present invention may also be applied to, for example, an ink-jet printing apparatus.

Moreover, although in the present embodiment described above, the amount of misregistration is detected using a rectangular-wave signal obtained by comparing a sensor output from the pattern sensors 7a and 7b with a predetermined threshold voltage. However, this is not limitative, but the amount of misregistration may be calculated by calculating a barycentric position of a rectangular-wave signal or a peak position of a sensor output.

Moreover, although in the present embodiment, the surface gloss of the intermediate transfer belt 5 is detected, this is not limitative, but other detection means may be used as a detection unit.

Moreover, although in the present embodiment described above, three patterns of toner patterns of the same color and having different densities are detected, this is not limitative as long as toner patterns are of a plurality of types.

### OTHER EMBODIMENTS

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-161078 filed Jul. 22, 2011, which is hereby incorporated by reference herein in its entirety.

What is claimed is:

1. An image forming apparatus comprising:
an image bearing member;
a plurality of image forming units;
a control unit configured to control said plurality of image forming units so as to form a color registration pattern on said image bearing member; and
a detection unit configured to detect diffusely reflected light reflected on said image bearing member and the color registration pattern,
wherein said control unit compares a first output value output by said detection unit detecting the surface of said image bearing member with a second output value output by said detection unit detecting a low-reflectivity toner pattern formed on said image bearing member, and determines a density of the color registration pattern corresponding to the low-reflectivity toner pattern based on a result of the comparison.

2. An image forming apparatus according to claim 1, wherein said control unit determines a density of a high-reflectivity toner pattern formed on said image bearing member by using a third output value output by said detection unit detecting the high-reflectivity toner pattern so that an output value from said detection unit can be equal to a target value.

3. An image forming apparatus according to claim 1, wherein in determining densities of the low-reflectivity toner pattern and the high-reflectivity toner pattern, said control unit controls said plurality of image forming units to form a plurality of types of toner patterns of the same color and having different densities on said image bearing member, and regards an average value of a plurality of output values output by said detection unit detecting each toner pattern having the same density among the plurality of types of toner patterns of the same color and having different densities as an output value from said detection unit.

4. An image forming apparatus according to claim 2, wherein in determining a density of the high-reflectivity toner pattern, said control unit determines the density of the toner pattern so that a plurality of output values output by said detection unit detecting respective toner patterns of a plurality of high-reflectivity colors can be the same output values.

5. An image forming apparatus according to claim 1, wherein the high-reflectivity toner pattern is formed under the low-reflectivity toner pattern.

6. A control method for an image forming apparatus which has an image bearing member, a plurality of image forming units, a control unit that controls the plurality of image forming units so as to form a color registration pattern on the image bearing member, and a detection unit that detects diffusely reflected light reflected on the image bearing member and the color registration pattern, comprising:
a control step of the control unit comparing a first output value output by the detection unit detecting the surface of the image bearing member with a second output value output by the detection unit detecting a low-reflectivity toner pattern formed on the image bearing member, and determining a density of the color registration pattern corresponding to the low-reflectivity toner pattern based on a result of the comparison.

7. A non-transitory computer-readable storage medium storing a program for causing an image forming apparatus to implement a control method according to claim 6.

8. An image forming apparatus according to claim 1, wherein said control unit calculates the amount of misregistration of toner patterns other than a reference color toner pattern relative to the reference color toner pattern, and corrects for write timing of the respective toner patterns based on a write timing correction value of the respective toner patterns calculated according to the calculated amount of misregistration.
